(19) United States
(12) Patent Application Publication
(10) Pub. No.: US 2017/0365843 A1
(43) Pub. Date: Dec. 21, 2017

(54) ANODE, BATTERY, AND METHOD OF MANUFACTURING SAME

(71) Applicant: Sony Corporation, Tokyo (JP)

(72) Inventors: Kenichi Kawase, Fukushima (JP); Yukiko lijima, Tokyo (JP)

(21) Appl. No.: 15/690,912

(22) Filed: Aug. 30, 2017

Related U.S. Application Data
(62) Division of application No. 11/277,238, filed on Mar. 23, 2006.

(30) Foreign Application Priority Data
Mar. 25, 2005 (JP) P2005-088038

(51) Int. Cl. H01M 4/134; H01M 4/66; H01M 4/04; H01M 4/1395; H01M 10/0525; H01M 4/02

(52) U.S. Cl. CPC H01M 4/134; H01M 4/1395; H01M 10/0525; H01M 4/661; H01M 4/0426; H01M 4/0471; H01M 4/0435; H01M 4/0433; H01M 2004/027

(57) ABSTRACT

A battery capable of improving cycle characteristics is provided. An anode active material layer is formed by forming a precursor layer containing active material particles containing Si and Li as an element, and then heating the resultant. Thereby, the active material particles are bound to each other by sintering or fusing, and united three-dimensionally. Since Li is contained therein, the active material particles can be sufficiently sintered even if the heating temperature is low, 600 deg C.

### CROSS REFERENCES TO RELATED APPLICATIONS

This application is a division of U.S. patent application Ser. No. 11/277,238 filed Mar. 23, 2006, the entirety of which is incorporated herein by reference to the extent permitted by law. The present invention contains subject matter related to Japanese Patent Application JP 2005-88038 filed in the Japanese Patent Office on Mar. 25, 2005, the entire contents of which being incorporated herein by reference.

### BACKGROUND OF THE INVENTION

### 1. Field of the Invention

The present invention relates to an anode having an anode active material layer containing silicon (Si) as an element, a battery using it, and a method of manufacturing the anode and the battery.

### 2. Description of the Related Art

In recent years, as mobile devices have been sophisticated and multi-functionalized, a higher capacity of secondary batteries as a power source for these mobile devices has been highly demanded. As a secondary battery to meet such a demand, there is a lithium secondary battery. However, the battery capacity in the case that lithium cobaltate is used for the cathode and graphite is used for the anode, which is currently a typical form for the lithium secondary batteries, is in a saturated state, and attaining a significantly high capacity thereof is in an extremely difficult situation. Therefore, from old times, it has been considered to use metal lithium (Li) for the anode. However, in order to put the anode to practical use, it is necessary to improve precipitation and dissolution efficiency of lithium and to control dendrite precipitation form.

Meanwhile, recently, the high capacity anode using silicon or the like has been actively considered. However, in such anodes, when charge and discharge is repeated, the active material is significantly expanded and shrunk, which leads to pulverization and miniaturization of the anode, current collectivity characteristics are lowered, the surface area is increased leading to accelerated decomposition reaction of the electrolytic solution, and the cycle characteristics are excessively poor. Therefore, an attempt to improve the cycle characteristics by coating the anode current collector with silicon particles and then providing heat treatment to sinter the active material layer has been made.

For example, in Japanese Unexamined Patent Application Publication No. H11-329433, descriptions are given of the anode, in which silicon particles and a fibrous reinforcement such as silicon dioxide and aluminum oxide are mixed and fired at from 800 deg C. to 1200 deg C. In Japanese Patent Publication No. 2948205, descriptions are given of the anode, in which silicon particles and a binder are mixed and fired at from 600 deg C. to 1400 deg C. Further, in Japanese Unexamined Patent Application Publication No. 2002-75332, descriptions are given of the anode, in which silicon particles and metal powder are mixed and fired.

### SUMMARY OF THE INVENTION

However, there is a disadvantage that in the foregoing methods, the high energy density inherent in silicon may not to be sufficiently utilized, and the cycle characteristics may not to be sufficiently improved. Further, there is another disadvantage that the melting point of silicon is high, and therefore sintering silicon particles with each other needs temperatures around 1000 deg C., leading to higher cost for mass production equipment.

In view of the foregoing, in the present invention, it is desirable to provide an anode capable of providing a high capacity and improving the cycle characteristics, a battery using it, and a method of manufacturing the same.

In the present invention, it is desirable to provide a method of manufacturing an anode and a method of manufacturing a battery capable of lowering the heating temperatures and reducing cost for manufacturing equipment.

According to an embodiment of the present invention, there is provided an anode having an anode current collector and an anode active material layer provided on the anode current collector, in which the anode active material layer has a structure in which active material particles containing silicon and lithium as an element are bound to each other by sintering or fusing.

According to an embodiment of the present invention, there is provided a battery including a cathode, an anode, and an electrolyte, in which the anode has an anode current collector and an anode active material layer provided on the anode current collector, and the anode active material layer has a structure in which active material particles containing silicon and lithium as an element are bound to each other by sintering or fusing.

According to an embodiment of the present invention, there is provided a method of manufacturing an anode including a step of forming an anode active material layer by forming a precursor layer containing active material particles containing silicon and lithium as an element on an anode current collector, heating the resultant, and thereby binding the active material particles to each other by sintering or fusing.

According to an embodiment of the present invention, there is provided a method of manufacturing a battery including a step of forming an anode by forming a precursor layer containing a plurality of active material particles containing silicon and lithium as an element on an anode current collector, heating the resultant, and thereby binding the active material particles to each other by sintering or fusing.

According to the anode of the embodiment of the present invention, the active material particles containing silicon and lithium are bound to each other by sintering or fusing. Therefore, the capacity can be improved and pulverization due to extraction and insertion of lithium can be inhibited. Therefore, according to the battery of the embodiment of the present invention, a high capacity can be obtained, and the battery characteristics such as cycle characteristics can be improved.

In particular, when the element of the anode current collector is diffused in the anode active material layer, the contact characteristics between the anode active material layer and the anode current collector are improved, and the cycle characteristics can be more improved.

Further, when an interlayer for inhibiting diffusion of the element is provided between the anode current collector and the anode active material layer, the element of the anode current collector is inhibited from being excessively diffused in the anode active material layer, and lowering of the capacity can be inhibited.

Further, according to the method of manufacturing an anode and the method of manufacturing a battery of the embodiment of the present invention, after the precursor layer containing the active material particles is formed, the resultant is heated. Therefore, even if heating is provided at temperatures lower than 1000 deg C., the active material particles can be sufficiently bound to each other by sintering or fusing. Consequently, the anode and the battery of the embodiment of the present invention can be easily manufactured, the heating temperature can be lowered, and the manufacturing equipment can be an affordable price. Further, a coat can be formed on the surface of the anode, and the capacity loss at an early stage of charge can be inhibited.

In particular, when the particles containing silicon are supported by the anode current collector and then lithium is vapor-deposited and thereby lithium is inserted therein, lithium can be easily and uniformly contained therein, and the anode and the battery of the embodiment of the present invention can be more easily manufactured.

Other and further objects, features and advantages of the invention will appear more fully from the following description.

### BRIEF DESCRIPTION OF THE DRAWINGS

FIG. 1 is a cross section showing a structure of an anode according to an embodiment of the present invention;

FIG. 2 is a cross section showing a modification of the anode shown in FIG. 1;

FIG. 3 is a cross section showing a structure of a secondary battery using the anode shown in FIG. 1;

FIG. 4 is an exploded perspective view showing a structure of another secondary battery using the anode shown in FIG. 1;

FIG. 5 is a cross section showing a structure taken along line I-I of a spirally wound electrode body shown in FIG. 4;

FIG. 6 is an SEM photograph showing a surface structure of an anode according to an example of the present invention; and

FIG. 7 is an SEM photograph showing a surface structure of an anode according to a comparative example relative to the present invention.

### DETAILED DESCRIPTION OF THE PREFERRED EMBODIMENT

An embodiment of the present invention will be hereinafter described in detail with reference to the drawings.

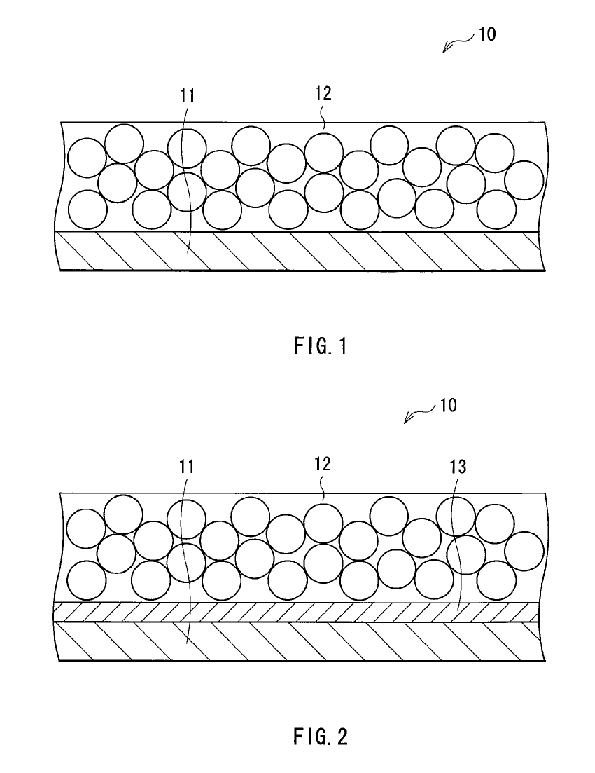

FIG. 1 simply shows a structure of an anode according to an embodiment of the present invention. An anode 10 has, for example, an anode current collector 11 and an anode active material layer 12 provided on the anode current collector 11. The anode active material layer 12 may be provided on the both faces or the single face of the anode current collector 11.

The anode current collector 11 is preferably made of a metal material containing at least one metal element not forming an intermetallic compound with lithium. When the intermetallic compound is formed with lithium, the anode is expanded and shrunk associated with charge and discharge, structural destruction occurs, and current collectivity is lowered. In addition, ability to support the anode active material layer 12 is lowered, and the anode active material layer 12 is easily fallen off from the anode current collector 11. As a metal element not forming an intermetallic compound with lithium, for example, copper (Cu), nickel (Ni), titanium (Ti), iron (Fe), and chromium (Cr) can be cited.

As a metal material composing the anode current collector 11, further, a metal material containing a metal element being alloyed with the anode active material layer 12 is preferable. As described later, when the anode active material layer 12 contains silicon as an element, the anode active material layer 12 is largely expanded and shrunk associated with charge and discharge and is easily fallen off from the anode current collector 11. However, by alloying the anode active material layer 12 with the anode current collector 11 to strongly adhere, such separation can be inhibited. As a metal element not forming an intermetallic compound with lithium and being alloyed with the anode active material layer 12, that is, as a metal element being alloyed with silicon, copper, nickel, iron can be cited. Specially, copper is preferable since copper provides a sufficient strength and electrical conductivity.

The anode current collector 11 may include a single layer or a plurality of layers. In the latter case, the layer contacting with the anode active material layer 12 may be made of a metal material being alloyed with silicon, and other layers may be made of other metal material.

As an anode current collector 11, a thin film being about from 10 μm to 30 μm thick is preferable in order to improve productivity and battery characteristics. However, the anode current collector 11 may be made of a foam metal or a nonwoven of a fibrous metal or the like.

The anode active material layer 12 has a structure in which a plurality of active material particles 12A containing silicon and lithium as an element are bound to each other by sintering or fusing. Thereby, the anode active material layer 12 is three-dimensionally united, and therefore pulverization due to insertion and extraction of lithium can be inhibited.

The active material particles 12A may be made of an alloy of silicon and lithium. Otherwise, the active material particles 12A may be made of an alloy further containing one or more other elements such as copper, nickel, iron, germanium, titanium, and cobalt. Further, the active material particles 12A may be partly oxidized or carbonized. However, the silicon content is preferably higher in order to obtain a higher capacity. For example, the silicon content in the anode active material layer 12 is preferably 50 volume % or more. Further, the active material particles 12A may be monocrystal, polycrystal, amorphous, or in a mixed state thereof. However, plenty of silicon single phase preferably exists in order to improve the capacity. Only one kind of the active material particles 12A may be used singly or two or more kinds thereof may be used by mixing.

The anode active material layer 12 may contain one or more other anode active materials in addition to the active material particles 12A. Further, the anode active material layer 12 may contain an electrical conductor made of a carbon material, a metal material or the like or a binder. As a binder, known materials may be used. For example, polyvinylidene fluoride, polyamide, polyamideimide, polyimide, a phenol resin, polyvinyl alcohol, or styrene butadiene rubber can be cited. Though the anode 10 can be formed without using the binder, the binder is preferably used in order to improve formability and facilitate handling in the manufacturing steps. Further, in some cases, the binder preferably remains in the anode 10 after the manufacturing steps are finished in order to improve binding characteristics.

At least part of the element of the anode current collector 11 is preferably diffused in the anode active material layer 12. Thereby, contact characteristics between the anode current collector 11 and the anode active material layer 12 can be improved. However, when the diffusion amount is increased, an intermetallic compound of silicon and the element of the anode current collector 11 is formed and the capacity is lowered. Therefore, for example, as shown in FIG. 2, an interlayer 13 for inhibiting diffusion of the element may be provided between the anode current collector 11 and the anode active material layer 12. The interlayer 13 is preferably made of, for example, a high melting point metal material containing molybdenum (Mo) or the like, a material not being alloyed with silicon such as iridium (Ir), an oxide, or a nitride.

The anode 10 can be manufactured as follows, for example.

### (First Manufacturing Method)

First, for example, the active material particles 12A containing silicon and lithium as an element are prepared. The active material particles 12A, and if necessary an electrical conductor or a binder are mixed by using a disperse medium. Next, the anode current collector 11 is coated with the mixture, the active material particles 12A are supported, and thereby a precursor layer is formed. It is possible that the interlayer 13 is formed on the anode current collector 11, and the precursor layer is formed on the interlayer 13. Subsequently, it is preferable that after the disperse medium is volatilized and removed according to needs, the precursor layer is pressed by a roll pressing machine to obtain a dense layer.

After that, the precursor layer is heated, for example, in non-oxidizing atmosphere, the active material particles 12A are bound to each other by sintering or fusing to form the anode active material layer 12. The melting point of silicon is originally high about 1400 deg C., and therefore heating should be provided at high temperatures, 1000 deg C. or more for binding silicon particles with each other. However, according to this embodiment, lithium with the melting point of 180 deg C. is compounded, and therefore even if heating is provided at temperatures lower than 1000 deg C., the active material particles 12A can be sufficiently bound to each other. Further, accordingly, when a binder whose high temperature durability is high is used, part thereof can remain in the anode active material layer 12.

It is possible that an alloy of silicon and other element is used, the composition in the vicinity of the eutectic point thereof is targeted to lower the melting point. In this case, however, there are large adverse effects as follows. For example, lowered silicon content leads to a lowered capacity, or silicon forms a strongly bonded compound with other element, which leads to electrochemical inactive state of lithium. Meanwhile, when lithium is compounded with silicon, capacity lowering does not occur since silicon is not electrochemically inactivated.

Further, by the foregoing heating treatment, for example, the element of the anode current collector 11 is diffused in the anode active material layer 12. Further, for example, a coat is formed on the surface of the anode active material layer 12, and thereby side reaction other than electrode reaction can be inhibited.

The temperature used when heating the precursor layer is preferably equal to or less than the melting point of the anode current collector 11. For example, when the anode current collector 11 is made of copper or a material mainly containing copper, the temperature is preferably equal to or less than the melting point of copper. When the heating temperature is high, the element of the anode current collector 11 is excessively diffused in the anode active material layer 12. Specifically, though depending on the lithium content, the heating temperature is, for example, preferably in the range from 350 deg C. to 800 deg C. As a heating method, a vacuum furnace or a gas replacement furnace may be used; a heating roll may be contacted to the precursor layer or a heater may be used; or plasma heating for applying a large current instantly to the base material may be used. Thereby, the anode 10 shown in FIG. 1 is obtained.

### (Second Manufacturing Method)

Further, instead of using the active material particles 12A containing silicon and lithium, the anode 10 may be manufactured by using particles containing silicon but not containing lithium. For example, particles containing silicon but not containing lithium and if necessary an electrical conductor or a binder are mixed by using a disperse medium. The anode current collector 11 is coated with the mixture, which is supported. After that, lithium is inserted therein to form a precursor layer. The heating steps after forming the precursor layer are the same as in the first manufacturing method.

As a method for inserting lithium, for example, it is preferable that lithium is vapor-deposited and diffused on the surface of the particles containing silicon, which are supported by the anode current collector 11. Thereby, lithium can be easily and uniformly inserted by diffusion. For vapor deposition, a known method such as resistance heating, induction heating, and electron beam heating can be used.

The vapor deposition amount of lithium is preferably under the insertion amount of lithium of the particles containing silicon supported by the anode current collector 11 per unit area. When the vapor deposition amount of lithium is excessive, lithium metal remains on the surface of the anode active material layer 12, which causes lowering of the battery characteristics.

The anode 10 is used for the secondary battery as follows, for example.

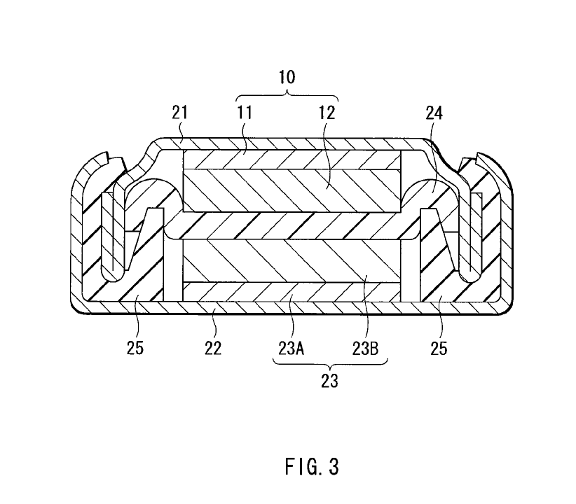

FIG. 3 shows a structure of the secondary battery. The secondary battery is a so-called coin-type secondary battery, in which the anode 10 contained in a package cup 21 and a cathode 23 contained in a package can 22 are layered with a separator 24 in between.

Peripheral edges of the package cup 21 and the package can 22 are hermetically sealed by being caulked through an insulating gasket 25. The package cup 21 and the package can 22 are respectively made of a metal such as stainless and aluminum.

The cathode 23 has, for example, a cathode current collector 23A and a cathode active material layer 23B provided on the cathode current collector 23A. Arrangement is made so that the cathode active material layer 23B side is opposed to the anode active material layer 12. The cathode current collector 23A is made of, for example, aluminum, nickel, and stainless.

The cathode active material layer 23B contains, for example, as a cathode active material, one or more cathode materials capable of inserting and extracting lithium. The cathode active material layer 23B may contain an electrical conductor such as a carbon material and a binder such as polyvinylidene fluoride according to needs. As a cathode material capable of inserting and extracting lithium, for example, a chalcogenide not containing lithium, or a lithium complex oxide containing lithium can be cited. As a lithium complex oxide, for example, the lithium complex oxide expressed by a general formula, LiₓMO₂ is preferable, since thereby a high voltage can be generated and a high energy density can be obtained. M preferably contains one or more transition metal elements, and for example, preferably contains at least one of cobalt and nickel. x varies according to charge and discharge state of the battery, and is generally in the range of 0.05≦x≦1.10. As a specific example of such a lithium containing metal complex oxide, LiCoO₂, LiNiO₂ or the like can be cited. When such a lithium complex oxide is used, the lithium complex oxide is preferably incorporated in the battery in a state that lithium thereof is insufficient by being extracted therefrom, since lithium is contained in the anode 10.

The cathode 23 can be formed as follows, for example. A mixture is prepared by mixing a cathode active material, an electrical conductor, and a binder. The mixture is dispersed in a disperse medium such as N-methyl-2-pyrrolidone to form mixture slurry. The cathode current collector 23A made of a metal foil is coated with the mixture slurry, which is dried and compression-molded to form the cathode active material layer 23B.

The separator 24 separates the anode 10 from the cathode 23, prevents current short circuit due to contact of the both electrodes, and lets through lithium ions. The separator 24 is made of, for example, polyethylene or polypropylene.

An electrolytic solution, which is a liquid electrolyte, is impregnated in the separator 24. The electrolytic solution contains, for example, a solvent and an electrolyte salt dissolved in a solvent. The electrolytic solution may contain an additive according to needs. As a solvent, for example, a nonaqueous solvent such as ethylene carbonate, propylene carbonate, dimethyl carbonate, diethyl carbonate, ethyl methyl carbonate, and vinylene carbonate can be cited. One of the solvents may be used singly, or two or more thereof may be used by mixing.

As an electrolyte salt, for example, a lithium salt such as LiPF₆, LiCF₃SO₃, and LiClO₄ can be cited. One of the electrolyte salts may be used singly, or two or more thereof may be used by mixing.

The secondary battery can be manufactured by, for example, layering the anode 10, the separator 24 impregnated with the electrolytic solution, and the cathode 23, containing the lamination between the package cup 21 and the package can 22, and caulking the package cup 21 and the package can 22.

In the secondary battery, since lithium is previously contained in the anode 10, discharge can be started from the first. First, when discharged, for example, lithium ions are extracted from the anode 10, and inserted in the cathode 23 through the electrolytic solution. Next, when charged, for example, lithium ions are extracted from the cathode 23 and inserted in the anode 10 through the electrolytic solution. At that time, the anode active material layer 12 is largely expanded and shrunk associated with extraction and insertion of lithium. However, in this embodiment, since the active material particles 12A are bound to each other by sintering or fusing and united three-dimensionally, pulverization thereof is inhibited.

The anode 10 according to this embodiment may be used for the following secondary battery.

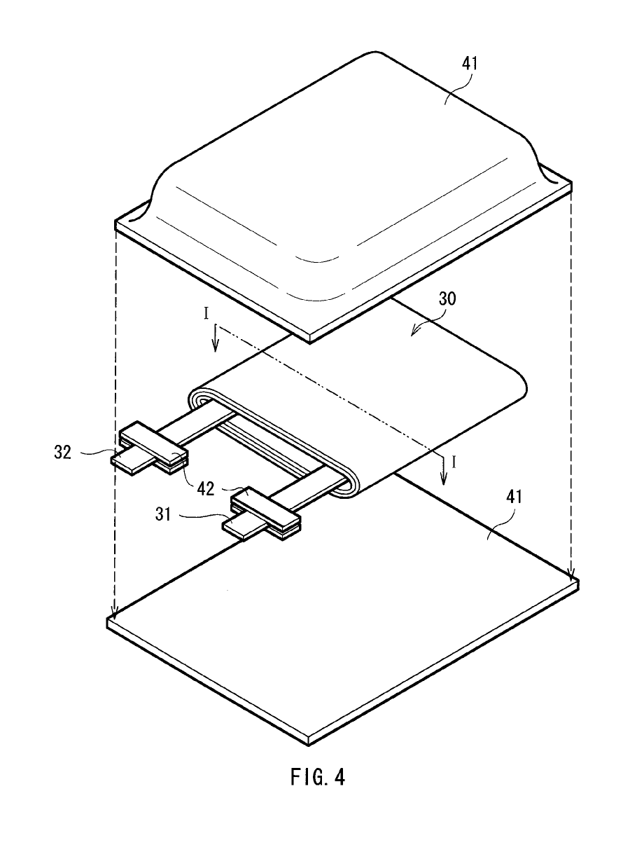

FIG. 4 shows a structure of the secondary battery. In the secondary battery, a spirally wound electrode body 30 on which leads 31 and 32 are attached is contained inside a film package member 41. Thereby, a small, light, and thin secondary battery can be obtained.

The leads 31 and 32 are respectively directed from inside to outside of the package member 41 and derived in the same direction, for example. The leads 31 and 32 are respectively made of, for example, a metal material such as aluminum, copper, nickel, and stainless, and are in a state of thin plate or mesh, respectively.

The package member 41 is made of a rectangular aluminum laminated film, in which, for example, a nylon film, an aluminum foil, and a polyethylene film are bonded together in this order. The package member 41 is, for example, arranged so that the polyethylene film side and the spirally wound electrode body 30 are opposed to each other, and the respective outer edges are contacted to each other by fusion bonding or an adhesive. Adhesive films 42 to protect from outside air intrusion are inserted between the package member 41 and the leads 31 and 32. The adhesive film 42 is made of a material having contact characteristics to the leads 31 and 32 such as a polyolefin resin of polyethylene, polypropylene, modified polyethylene, and modified polypropylene.

The package member 41 may be made of a laminated film having other structure, a high molecular weight film such as polypropylene, or a metal film, instead of the foregoing aluminum laminated film.

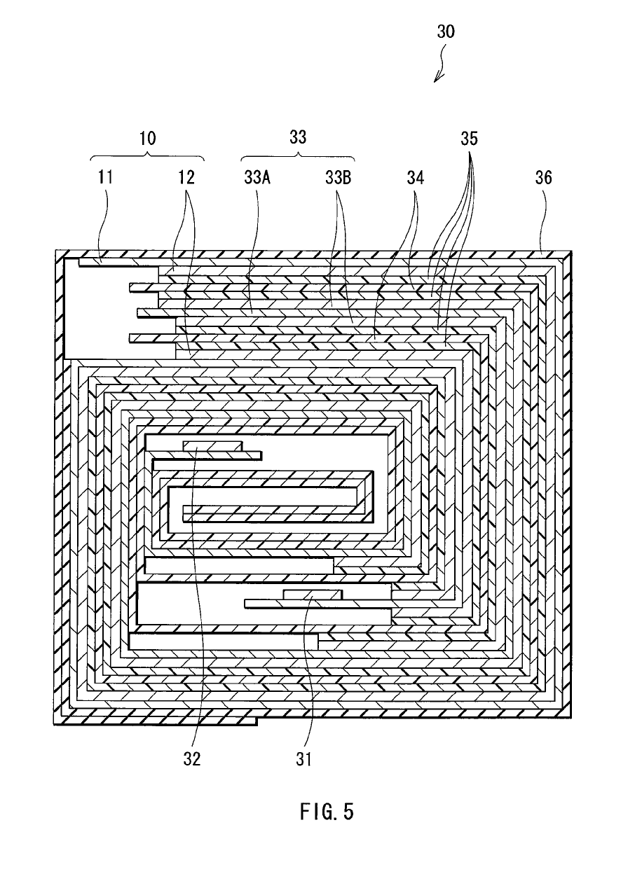

FIG. 5 shows a cross section structure taken along line I-I of the spirally wound electrode body 30 shown in FIG. 4. In the spirally wound electrode body 30, the anode 10 and a cathode 33 are layered with a separator 34 and an electrolyte layer 35 in between and wound. The outermost periphery thereof is protected by a protective tape 36.

The anode 10 has a structure in which an anode active material layer 12 is provide on the both faces of an anode current collector 11. The cathode 33 also has a structure in which a cathode active material layer 33B is provided on the both faces of a cathode current collector 33A. Arrangement is made so that the cathode active material layer 33B side is opposed to the anode active material layer 12. The structures of the cathode current collector 33A, the cathode active material layer 33B, and the separator 34 are similar to of the cathode current collector 23A, the cathode active material layer 23B, and the separator 24 respectively described above.

The electrolyte layer 35 is made of a so-called gelatinous electrolyte, in which an electrolytic solution is held in a high molecular weight compound. The gelatinous electrolyte is preferable, since a high ion conductivity can be thereby obtained, and leak of the battery and swollenness of the battery at high temperatures can be thereby prevented. The composition of the electrolytic solution (that is, a solvent and an electrolyte salt) is similar to of the coin-type secondary battery shown in FIG. 3. As a high molecular weight material, for example, polyvinylidene fluoride can be cited.

The secondary battery can be manufactured, for example, as follows. First, the electrolyte layer 35, in which the electrolytic solution is held in the high molecular weight compound is formed on the anode 10 and the cathode 33, respectively. After that, the lead 31 is attached to the end of the anode current collector 11 by welding, and the lead 32 is attached to the end of the cathode current collector 33A by welding. Next, the anode 10 and the cathode 33 formed with the electrolyte layer 35 are layered with the separator 34 in between to form the lamination. After that, the lamination is wound in the longitudinal direction. The protective tape 36 is adhered to the outermost periphery thereof to form the spirally wound electrode body 30. Lastly, for example, the spirally wound electrode body 30 is sandwiched between the package members 41, and outer edges of the package members 41 are contacted by thermal fusion bonding or the like to enclose the spirally wound electrode body 30. Then, the adhesive films 42 are inserted between the leads 31, 32 and the package member 41. Thereby, the secondary battery shown in FIG. 4 and FIG. 5 is completed.

The operation of the secondary battery is similar to of the coin-type secondary battery shown in FIG. 3.

As above, according to this embodiment, since the active material particles 12A containing silicon and lithium are bound to each other by sintering or fusing, pulverization due to extraction and insertion of lithium can be inhibited without lowering the capacity. Therefore, a high capacity can be obtained, and the battery characteristics such as cycle characteristics can be improved. Further, since lithium is previously contained in the anode 10, discharge can be started from the first, and the step of charging the battery after assembling the battery can be excluded. Therefore, the manufacturing steps can be simplified, and the manufacturing cost can be lowered.

Further, when the element of the anode current collector 11 is diffused in the anode active material layer 12, the contact characteristics between the anode active material layer 12 and the anode current collector 11 can be improved, and the cycle characteristics can be improved.

In addition, when the interlayer 13 is provided between the anode current collector 11 and the anode active material layer 12, the element of the anode current collector 11 is inhibited from being excessively diffused in the anode active material layer 12, and lowering of the capacity can be inhibited.

Furthermore, according to this embodiment, after the precursor layer containing the active material particles 12A is formed, heating is provided. Therefore, even if heating is provided at temperatures lower than 1000 deg C., the active material particles 12A can be sufficiently bound to each other by sintering or fusing. Consequently, the anode 10 and the battery according to this embodiment can be easily manufactured, the heating temperature can be lowered, and the manufacturing equipment can be an affordable price. Further, a coat can be formed on the surface of the anode active material layer 12, and therefore the capacity loss at an early stage of charge can be inhibited.

In particular, when the particles containing silicon are supported by the anode current collector 11 and then lithium is vapor-deposited and thereby lithium is inserted therein, lithium can be easily and uniformly contained therein and the manufacturing can be more facilitated.

### EXAMPLES

Further, specific examples of the present invention will be hereinafter described in detail with reference to the drawings. In the following examples, the symbols used in the foregoing the embodiment are directly and correspondingly used.

As Example 1, the anode 10 shown in FIG. 1 was formed. First, silicon powder with an average particle diameter of 6 μm as particle containing silicon and polyvinylidene fluoride as a binder were mixed at a weight ratio of silicon powder:polyvinylidene fluoride=95:5. The mixture was dispersed in N-methyl-2-pyrrolidone as a disperse medium to obtain slurry. Next, the anode current collector 11 made of a copper foil being 20 μm thick was uniformly coated with the slurry, which was dried to remove the disperse medium, and the coating layer was compression-molded by a roll pressing machine. Subsequently, the anode current collector 11 was mounted on a water-cooled flat pedestal being 200 mm in outer diameter, lithium was vapor-deposited on the coating layer by resistance heating vapor deposition method to form a precursor layer. At that time, as a vapor deposition source, a source in which chips of lithium are put into a crucible made of stainless around which a tungsten wire is wound was used. The vacuum degree was 1×10⁻³ Pa. Further, the deposition amount of lithium was adjusted so that the atomicity ratio of silicon and lithium became 50:50. After that, the anode current collector 11 formed with the precursor solution layer was put in a firing furnace and provided with heating treatment for 2 hours at 650 deg C. in the argon atmosphere. Thereby, the anode 10 was formed.

As Example 2, the anode 10 was formed as in Example 1, except that Si—Ti alloy with an average particle diameter of 5 μm was used as particle containing silicon. At that time, as Si—Ti alloy, an alloy obtained by mixing silicon powder and titanium powder at an atomicity % of silicon powder:titanium powder=80:20, previously melting the mixture in an arc melting furnace to form an alloy ingot, forming alloy powder therefrom by a single-roll melting and quenching equipment, and pulverizing the alloy powder by using a ball mill was used.

As Example 3, the anode 10 was formed as in Example 1, except that silicon monoxide (SiO) powder with an average particle diameter of 7 μm was used as particle containing silicon.

As Example 4, the anode 10 was formed as in Example 1, except that the heat treatment time in the firing furnace was 8 hours.

As Example 5, the anode 10 was formed as in Example 1, except that after the interlayer 13 made of molybdenum was formed on the surface of the anode current collector 11 made of a copper foil by electron beam vapor deposition method, the precursor layer was formed.

As Comparative example 1 relative to the examples, an anode was formed as in Example 1, except that vapor deposition of lithium and heating treatment were not provided.

As Comparative example 2, an anode was formed as in Example 1, except that vapor deposition of lithium was not provided.

As Comparative example 3, an anode was formed as in Example 1, except that heating treatment was not provided.

As Comparative example 4, an anode was formed as in Example 1, except that vapor deposition of lithium was not provided, and the heating temperature in the firing furnace was 1200 deg C.

As Comparative example 5, an anode was formed as in Example 1, except that aluminum was vapor-deposited instead of lithium.

As Comparative example 6, an anode was formed as in Example 1, except that silicon powder with an average particle diameter of 6 μm as particle containing silicon, indium powder with an average particle diameter of 5 μm as other particle, and polyvinylidene fluoride as a binder were mixed at a weight ratio of silicon powder:indium powder:polyvinylidene fluoride=80:15:5, the mixture was dispersed in N-methyl-2-pyrrolidone as a disperse medium to obtain slurry, by which a coating layer was formed, and lithium was not vapor-deposited.

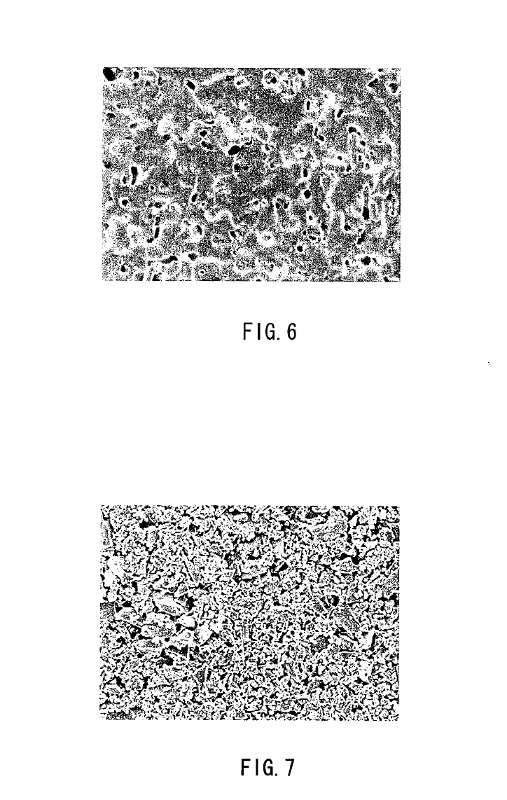

For the formed anodes 10 of Examples 1 to 5 and Comparative examples 1 to 6, the surface was observed by Scanning Electron Microscope (SEM). In Examples 1 to 5, the active material particles 12A were bound to each other by sintering or fusing. However, in Comparative examples 1 to 6, the particles were not bound to each other by sintering or fusing. As an example, an SEM photograph of Example 4 is shown in FIG. 6, and an SEM photograph of Comparative example 2 is shown in FIG. 7. Further, for the anodes 10 of Examples 1 to 5, the anode active material layer 12 was analyzed by a scanning analytical electron microscope (SEM-EDX) using a scanning electron microscope and an energy dispersive X-ray spectrometer (EDX) together. Then, it was confirmed that copper as an element of the anode current collector 11 was dispersed in the active material particles 12A.

### <Evaluation 1>

Coin-type test batteries as shown in FIG. 3 were fabricated by using the anodes 10 of Examples 1 to 5 and Comparative examples 1 to 6. As a counter electrode, a lithium metal plate being 1.2 mm thick was used. As a separator, a polypropylene film being 25 μm thick was used. As an electrolytic solution, a solution obtained by dissolving LiPF₆ at a concentration of 1 mol/l in a mixed solvent of ethylene carbonate, dimethyl carbonate, and vinylene carbonate at a volume ratio of ethylene carbonate:dimethyl carbonate:vinylene carbonate=30:65:5 was used.

For each fabricated test battery, charge and discharge test was performed and the discharge capacity retention ratio at the 50th cycle to the first cycle was obtained. At that time, charge was performed until the battery voltage reached 0 V at a constant current density of 1 mA/cm², and then performed until the current value reached 0.1 mA at a constant voltage of 0 V. Discharge was performed until the battery voltage reached 1.5 Vat a constant current density of 1 mA/cm². The results are shown in Table 1.

### <Evaluation 2>

Coin-type batteries as shown in FIG. 3 were fabricated by using the anodes 10 of Examples 1 to 5 and Comparative examples 1 to 6. The cathode 23 was fabricated as follows. Lithium cobaltate (LiCoO₂) was used as a cathode active material. Lithium cobaltate, carbon black as an electrical conductor, and polyvinylidene fluoride as a binder were mixed at a weight ratio of LiCoO₂:carbon black:polyvinylidene fluoride=92:3:5. The mixture was dispersed in N-methyl-2-pyrrolidone as a disperse medium to form mixture slurry. After that, the cathode current collector 23A made of an aluminum foil was coated with the mixture slurry, which was dried to form the cathode 23. Then, based on the lithium content and the capacity of silicon of the anodes 10 of Examples 1 to 5 and Comparative examples 1 to 6, design was made so that lithium metal was not precipitated on the anode 10 even if fully charged up to 4.2 V. Further, for the separator 24 and the electrolytic solution, a separator and an electrolytic solution similar to of the coin-type test battery fabricated in Evaluation 1 were used.

For each fabricated secondary battery, charge and discharge test was performed and the discharge capacity retention ratio at the 100th cycle to the first cycle was obtained. At that time, charge was performed until the battery voltage reached 4.2 V at a constant current density of 1 mA/cm², and then performed until the current value reached 0.1 mA at a constant voltage of 4.2 V. Discharge was performed until the battery voltage reached 2.5 Vat a constant current density of 1 mA/cm². The results are shown in Table 1.

### <Evaluation 3>

Secondary batteries capable of being discharged from the first were fabricated as in Evaluation 2, except that the anodes 10 of Examples 1 to 5 and Comparative example 3 provided with vapor deposition of lithium by resistance heating vapor deposition method were used, and lithium cobaltate (LiCoO₂) as a cathode active material from which lithium was partly extracted was incorporated in the battery. At that time, as in the secondary batteries fabricated in Evaluation 2, design was made so that lithium metal was not precipitated on the anode 10 even if fully charged up to 4.2 V.

For each fabricated secondary battery, charge and discharge test was performed and the discharge capacity retention ratio at the 100th cycle to the second cycle was obtained. Then, discharge was performed until the battery voltage reached 2.5 V at a constant current density of 1 mA/cm². Charge was performed until the battery voltage reached 4.2 V at a constant current density of 1 mA/cm², and then performed until the current value reached 0.1 mA at a constant voltage of 4.2 V. The results are shown in Table 1. The initial discharge capacities of the secondary batteries using the anodes 10 of Examples 1, 4, and 5 are shown in Table 1 together as a relative value where the value of Example 1 is 100.

TABLE 1

| | | | | | | | | | Initial |
|---|---|---|---|---|---|---|---|---|---|
| | | | | | | | | | discharge |
| | | | Heating treatment | | | | | | capacity |
| | Coating | Vapor | Temperature | Time | | Discharge capacity retention ratio (%) | | | (relative |
| | particle | deposition | (deg C.) | (hour) | Interlayer | Evaluation 1 | Evaluation 2 | Evaluation 3 | value) |
| Example 1 | Si | Li | 650 | 2 | N/A | 97 | 95 | 91 | 100 |
| Example 2 | Si—Ti | Li | 650 | 2 | N/A | 95 | 92 | 88 | — |
| | alloy | | | | | | | | |
| Example 3 | SiO | Li | 650 | 2 | N/A | 96 | 90 | 91 | — |
| Example 4 | Si | Li | 650 | 8 | N/A | 98 | 96 | 93 | 72 |
| Example 5 | Si | Li | 650 | 8 | Mo | 97 | 96 | 92 | 91 |
| Comparative | Si | N/A | N/A | N/A | N/A | 38 | 30 | — | — |
| example 1 | | | | | | | | | |
| Comparative | Si | N/A | 650 | 2 | N/A | 65 | 48 | — | — |
| example 2 | | | | | | | | | |
| Comparative | Si | Li | N/A | N/A | N/A | 49 | 41 | 37 | — |
| example 3 | | | | | | | | | |
| Comparative | Si | N/A | 1200 | 2 | N/A | 22 | 5 | — | — |
| example 4 | | | | | | | | | |
| Comparative | Si | Al | 650 | 2 | N/A | 69 | 50 | — | — |
| example 5 | | | | | | | | | |
| Comparative | Si + In | N/A | 650 | 2 | N/A | 68 | 49 | — | — |
| example 6 | | | | | | | | | |

As evidenced by Table 1, according to Examples 1 to 5, in which the particles containing silicon were used, lithium was vapor-deposited thereto, heating was provided, and thereby the active material particles 12A were bound to each other by sintering or fusing, the discharge capacity retention ratio was improved more than in Comparative examples 1, 2, and 4 to 6, in which lithium was not vapor-deposited and Comparative examples 1 and 3, in which heating treatment was not provided. That is, it was found that when the active material particles 12A containing silicon and lithium were heated, the active material particles 12A could be sufficiently bound to each other by sintering or fusing and the cycle characteristics could be significantly improved, even if the heating temperature was lowered down to less than 1000 deg C.

Further, according to Examples 4 and 5, in which the heating treatment time was lengthened compared to in Example 1, though the cycle characteristics were improved, the initial discharge capacity was lowered. However, in Example 5, in which the interlayer 13 was formed, the lowering degree of the initial discharge capacity was smaller than in Example 4, in which the interlayer 13 was not formed. That is, it was found that when the interlayer 13 was formed, lowering of the capacity could be inhibited.

The present invention has been described with reference to the embodiment and the examples. However, the present invention is not limited to the foregoing embodiment and examples, and various modifications may be made. For example, in the foregoing embodiment and examples, descriptions have been given of the case using the electrolytic solution or the gelatinous electrolyte, in which an electrolytic solution is held in a high molecular weight compound as an electrolyte. However, other electrolyte may be used. As other electrolyte, an inorganic conductor containing lithium nitride, lithium phosphate or the like, a high molecular weight solid electrolyte, in which an electrolyte salt is dispersed in a high molecular weight compound having ion conductivity, a mixture of the foregoing and an electrolytic solution and the like can be cited.

Further, in the foregoing embodiment and examples, descriptions have been given of the coin-type secondary battery or the spirally wound laminated-type secondary battery. However, the present invention can be similarly applied to a secondary battery such as a cylinder-type battery, a square-type battery, a button-type battery, a thin-type battery, a large-type battery, and a lamination-type battery. In addition, the present invention can be applied to primary batteries in addition to the secondary batteries.

It should be understood by those skilled in the art that various modifications, combinations, sub-combinations and alternations may occur depending on design requirements and other factors insofar as they are within the scope of the appended claims or the equivalents thereof.

What is claimed is:

1. A method of manufacturing an anode including:
providing a precursor layer containing anode active material particles containing silicon (Si) and lithium (Li) on an anode current collector;
heating the precursor layer; and
binding the anode active material particles to each other by sintering or fusing to form an anode active material layer.

2. The method of claim 1, wherein forming the precursor layer comprises:
providing the anode active material particles; and
supporting the active material particles on the anode current collector.

3. The method of claim 1, wherein forming the precursor layer comprises:
providing particles containing silicon as an element;
supporting the particles containing silicon on the anode current collector; and then
inserting lithium into the particles containing silicon.

4. The method of claim 3, wherein inserting lithium into the particles containing silicon comprises subjecting the supported particles containing silicon to vapor-deposition of lithium.

5. The method of claim 1, wherein, forming the precursor layer includes forming a layer with the anode active material particles and a binder.

6. The method of claim 1, wherein heating of the precursor layer subjecting the precursor to a heating temperature equal to or less than a melting point of the anode current collector.

7. The method of claim 1, wherein the anode current collector is made of a material containing copper (Cu), and the precursor layer is subject to a heating temperature equal to or less than a melting point of copper.

8. A method of manufacturing a battery comprising a cathode, an anode, and an electrolyte, the method comprising:
forming an anode by (a) providing a precursor layer containing anode active material particles containing silicon (Si) and lithium (Li) on an anode current collector, (b) heating the precursor layer, and (c) binding the anode active material particles to each other by sintering or fusing to form an anode active material layer; and
assembling the cathode, the anode, and the electrolyte into the battery.

9. The method of claim 8, wherein forming the precursor layer comprises:
providing the anode active material particles; and
supporting the active material particles on the anode current collector.

10. The method of claim 8, wherein forming the precursor layer comprises:
providing particles containing silicon as an element;
supporting the particles containing silicon on the anode current collector; and then
inserting lithium into the particles containing silicon.

11. The method of claim 10, wherein inserting lithium into the particles containing silicon comprises subjecting the supported particles containing silicon to vapor-deposition of lithium.

12. The method of claim 8, wherein, forming the precursor layer includes forming a layer with the anode active material particles and a binder.

13. The method of claim 8, wherein heating of the precursor layer subjecting the precursor to a heating temperature equal to or less than a melting point of the anode current collector.

14. The method of claim 8, wherein the anode current collector is made of a material containing copper (Cu), and the precursor layer is subject to a heating temperature equal to or less than a melting point of copper.
